(19) United States
(12) Patent Application Publication
(10) Pub. No.: US 2005/0115144 A1
(43) Pub. Date: Jun. 2, 2005

(54) Trap

(76) Inventor: John Haberfield, Bristol (GB)

Correspondence Address: STITES & HARBISON PLLC, 1199 NORTH FAIRFAX STREET, SUITE 900, ALEXANDRIA, VA, 22314, US

(21) Appl. No.: 10/504,572

(22) PCT Filed: Feb. 10, 2003
(86) PCT No.: PCT/GB03/00575

(30) Foreign Application Priority Data
Feb. 14, 2002 (GB) 0203635.8

(51) Int. Cl. A01M 23/20

(52) U.S. Cl. 43/61

(57) ABSTRACT

A trap is provided that comprises an enclosure (2) having an opening (3), with a door (4) for trapping an animal within the enclosure and a reflective surface (6) for attracting the animal into the enclosure.

### TECHNICAL FIELD OF THE INVENTION

The invention relates to a trap, and more specifically to a trap for capturing fish in a tropical or cold-water fish tank.

### BACKGROUND TO THE INVENTION

It is often a requirement to remove fish from fish tanks. The reason may be that the fish is a ‘bully’ to the other fish or that the fish is ill and needs to be quarantined. In any event, it is required that the fish is caught in a safe manner and that there is little disturbance to the fish being captured and the other fish in the tank.

In the traditional method of using a net, fish are often chased around the tank for some time before being caught, resulting in stress to the fish being captured, as well as to the other fish in the tank. In tanks that feature mini coral reefs, the net can also become snagged on the coral, causing damage to the net and to the coral itself.

Once captured, the fish is then removed from water for a short time before being replaced in a separate tank. This also causes stress to the fish.

This type of trap is known as an ‘active’ trap, in that the fish is actively pursued before being captured.

There are also a number of ‘passive’ traps available that entice fish into an open container using bait. The fish detects the presence of food and swims into the container. As soon as the fish is safely inside, the container is closed and the fish can be safely removed from the tank. This type of trap causes very little disturbance to the fish in the tank, and keeps the fish submerged in water at all times.

In such a trap, a fish is often reluctant to enter the trap, and additional bait is required. This may take the form of making the bait in the trap larger or by leaving a trail of bait from the fish to the trap.

However, many fish tanks (particularly in tropical fish aquariums) contain water that is carefully prepared and maintained to certain conditions and the use of an excessive amount of bait to attract a fish can upset the fine balance of conditions required to keep such fish healthy.

It is therefore desirable to provide a fish trap that captures a fish in a safe manner and that does not require the use of excessive amounts of bait.

### SUMMARY OF INVENTION

According to the invention, there is provided a fish trap comprising:
an enclosure having an opening for allowing the fish to enter the enclosure;
a door for trapping the fish within the enclosure;
characterised in that the trap has a reflective surface positioned opposite the opening, such that a fish at said opening can see its own reflection, thereby attracting the fish into the enclosure.

Preferably the reflective surface is positioned on a portion of one or more internal walls of the enclosure.

Alternatively the reflective surface is suspended within the enclosure.

Preferably the trap further comprises means for selectively changing the size of the opening.
This has the advantage of selecting the size of fish to be trapped.

Preferably the size of the opening is changed by slidably mounting one of a plurality of different sized apertures over the opening.

Alternatively, the size of the opening can be changed using the door.

Preferably the door is slidably mounted over the opening. This has the advantage of minimizing water disturbance.

Preferably the door is slidably mounted within first and second guides positioned either side of the opening.

Preferably the door has remote activating means for enabling the door to move between an open position and a closed position.

Advantageously the door moves between the open position and closed position under gravitational force.

Preferably the enclosure has a second opening for allowing bait to be inserted into the enclosure.

Preferably the trap further comprises a hollow channel extending outwardly from the second opening for aiding the insertion of bait.

Preferably the second opening is provided on an upper surface of the enclosure.

Preferably the reflective surface is a mirror.

Preferably the enclosure is made from transparent material.

According to method aspects of the present invention, a method is provided for capturing a fish, the method comprising:
providing an enclosure having an opening for allowing the fish to enter the enclosure;
providing a door for trapping the fish within the enclosure;
characterised in that a reflective surface is positioned opposite the opening, such that a fish at said opening can see its own reflection, thereby attracting the fish into the enclosure.

### BRIEF DESCRIPTION OF DRAWINGS

FIG. 1 shows a trap in accordance with a first embodiment of the invention.

FIG. 2a shows a trap in accordance with a second embodiment of the invention with the door in an open position.

FIG. 2b shows the trap of the second embodiment of the invention with the door in a closed position.

FIG. 3 shows a trap in accordance with a third embodiment.

FIGS. 4a, 4b and 4c show a trap in accordance with a fourth embodiment.

### DETAILED DESCRIPTION OF PREFERRED EMBODIMENTS

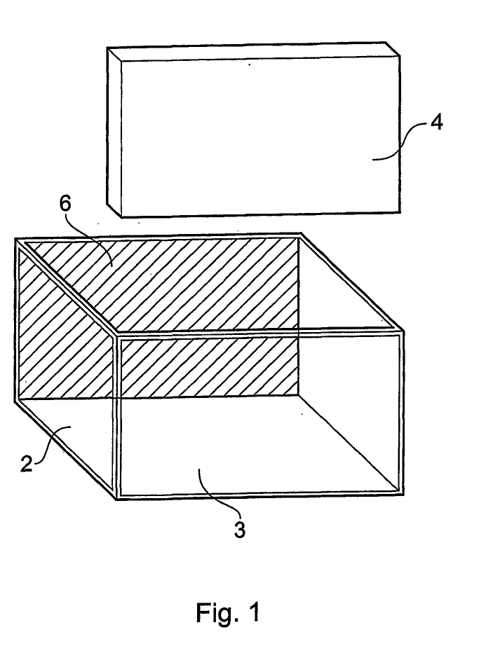

FIG. 1 shows a fish trap in accordance with a first embodiment of the invention. As is conventional, the trap consists of an enclosure 2 having an opening 3 and a door 4.

In accordance with the invention, a reflective surface 6 is placed on an internal face of the enclosure 2. Preferably, the reflective surface 6 is placed on the internal face that is opposite the opening 3. Advantageously, the reflective surface is a mirror, allowing a fish to clearly see its own reflection. The fish is attracted towards its own reflection in the mirror either through the desire to shoal with other fish or through the need to defend its territory. Either way, the fish will move towards its own reflection.

Once the fish is safely inside, the door 4 is closed over the opening 3 of the enclosure 2, trapping the fish. The door 4 is closed by allowing it to drop, or by sliding it into position to close the trap.

Although the enclosure 2 is shown to be cubical, it will be appreciated that the enclosure 2 can be any geometric shape, provided it has an internal reflective surface.

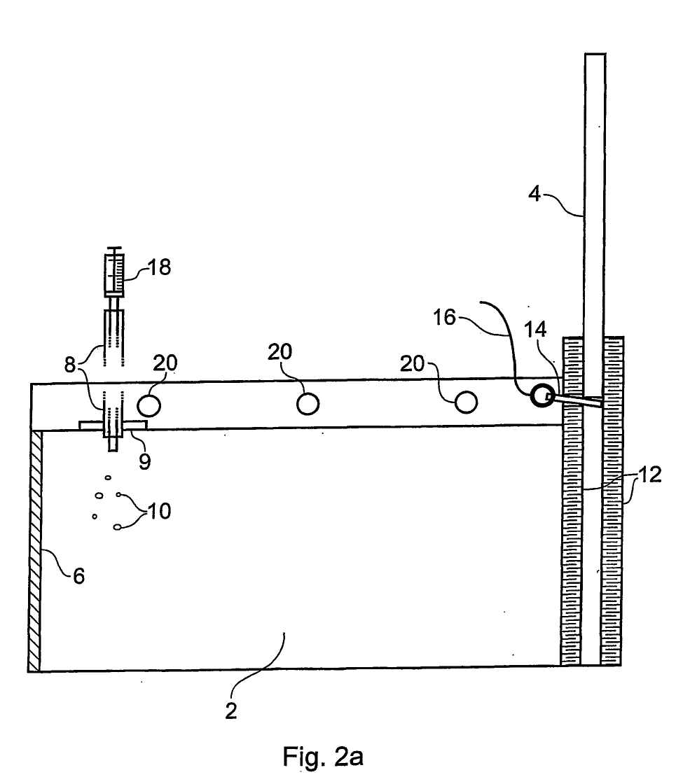

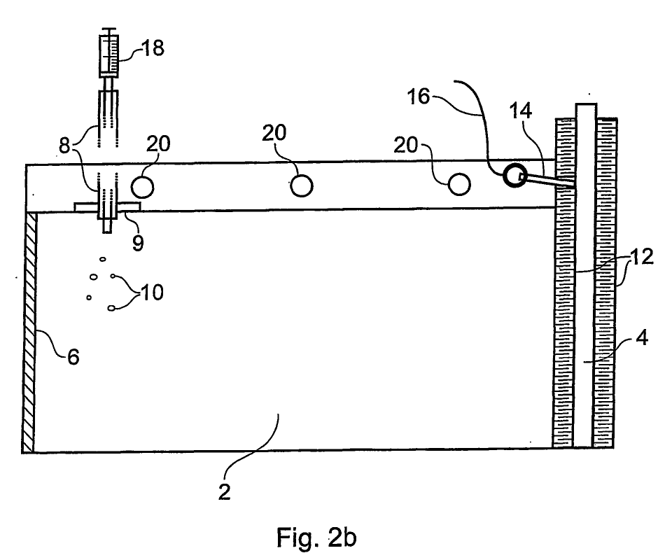

FIGS. 2a and 2b show a fish trap in accordance with a second embodiment of the invention.

As above, the trap consists of an enclosure 2 with a door 4. A reflective surface 6 is placed on an internal face of the enclosure 2. The door 4 is slidably mounted between two door supports 12. When the door 4 is in an open position (FIG. 2a), a pin 14 is located so that the door is prevented from closing. A cord 16 connected to the pin 14 allows the pin 14 to be pulled free, thereby allowing the door 4 to slide down between the door supports 12, trapping the fish in the enclosure 2. The cord 16 allows remote operation of the door 4.

According to the second embodiment, the top surface of the enclosure 2 has a second opening 9, into which a tube 8 is inserted for depositing a small amount of bait 10 inside the trap. The bait 10 may advantageously be put into the box 2 by a pipette 18 placed inside the tube 8. The use of a pipette 18, or similar device, allows the amount of bait 10 placed in the trap to be regulated, thereby avoiding contamination of the tank water as much as possible.

Holes 20 are provided on the top of the open-ended box 2 to allow the trap to be supported from the roof or sidewalls of a fish tank. This means that the trap can be supported away from the base of the tank, reducing the disturbance when the trap is positioned in place, and also means that the trap can be easily removed.

A fish looking into the open-ended box will see the small amount of bait 10, the reflection of itself and the reflection of the bait 10.

As before, the fish may be attracted towards its own reflection in the mirror, to the bait, or to the threat of competition for food potentially posed by its own reflection.

By placing a small amount of bait in front of the mirror, it appears to the fish that there is twice the amount of food available than there actually is. This means that less bait can be used than in a conventional bait trap, reducing the risk of fouling the fish tank water.

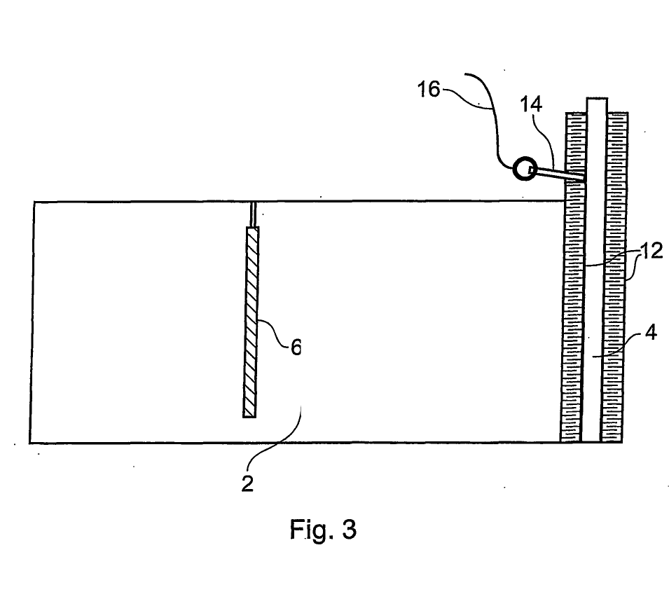

FIG. 3 shows a trap in accordance with a third embodiment of the invention.

As above, the trap consists of an enclosure 2 having an opening 3 and a door 4. A reflective surface 6 is suspended inside the enclosure 2, so that the reflective surface 6 is not in contact with any internal walls of the enclosure 2. Additionally, the reflective surface 6 may be free to rotate about a vertical axis.

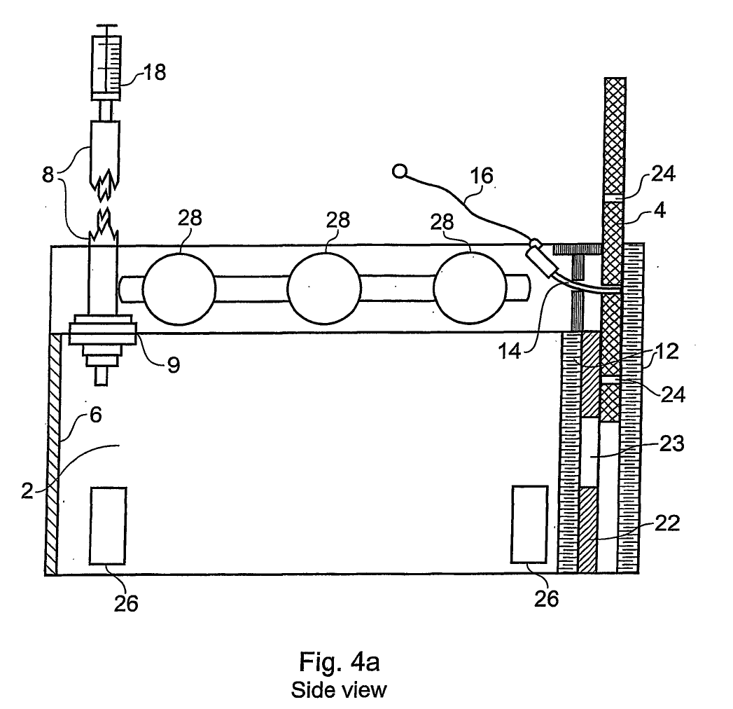

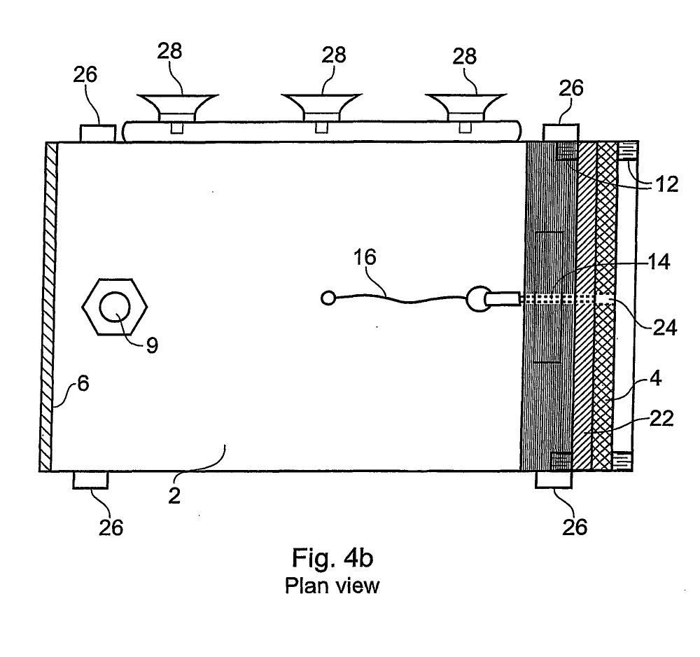

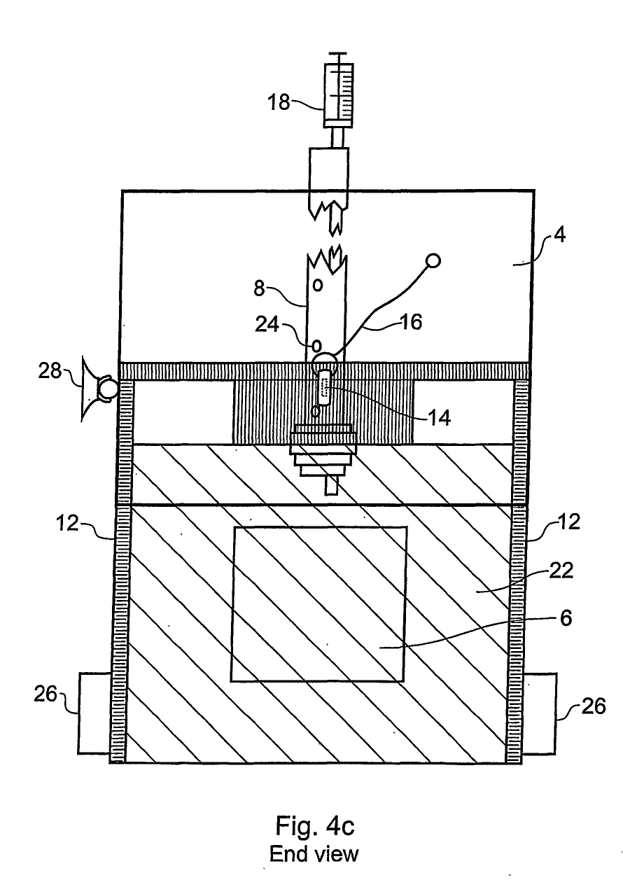

FIGS. 4a, 4b and 4c show a trap in accordance with a fourth embodiment of the invention.

Again, the trap consists of an enclosure 2 having an opening 3 and a door 4. A reflective surface 6 is placed on an internal face of the enclosure 2. The door 4 is slidably mounted between two door supports 12. When the door 4 is in an open position, a pin 14 is located in a pin slot 24 in the door 4 in order to hold the door 4 open. A cord 16 connected to the pin 14 allows the pin 14 to be pulled free of the pin slot 24, thereby allowing the door 4 to slide down between the door supports 12, trapping the fish in the enclosure 2. The cord 16 allows remote operation of the door 4.

The top surface of the enclosure 2 has a second opening 9, into which a tube 8 is inserted for depositing a small amount of bait 10 inside the trap. The bait 10 may advantageously be put into the box 2 by a pipette 18 placed inside the tube 8. The use of a pipette 18, or similar device, allows the amount of bait 10 placed in the trap to be regulated, thereby avoiding contamination of the tank water as much as possible.

The trap has a plurality of suction pads 28 that allow the trap to be secured to the side of the fish tank. This means that the trap can be supported away from the base of the tank, reducing the disturbance when the trap is positioned in place, and also means that the trap can be easily removed.

Additionally, spacers 26 may be provided to maintain a fixed distance between the trap and the sidewalls of the fish tank.

According to the third embodiment of the invention, a panel 22 containing an aperture 23 is placed over the opening 3 in order to restrict the size of the fish that can be caught by the trap. A plurality of panels 22 with different sized apertures 23 can be provided to allow a range of fish with different shapes and sizes to be captured. The panel 22 may be inserted using guides similar to the door supports 12. Alternatively, instead of using the panel 22, the size of the opening can be changed using the door 4. For example, additional pin slots 24 may be provided in the door 4, thereby allowing the door 4 to be held half open, quarter open, and so on.

Although the preferred embodiments show the reflective surface covering an entire internal surface, it will be clear to a person skilled in the art that the reflective surface can cover only a portion of one internal surface, or portions of two or more internal surfaces. Also, if the enclosure is made from a transparent material, the reflective surface may be mounted outside the enclosure, with the reflective surface facing inwards.

It is noted that, to assist the trapping of fish, a decoy in the form of an artificial fish may be placed within the container.

There is thus described an improved device for the capture of fish, which allows fish to be captured in a ‘passive’ and safe manner.

Although the preferred embodiment relates to a trap for capturing fish, it is noted that the trap can also be used to catch other animals.

1. A fish trap comprising:
an enclosure having an opening for allowing the fish to enter the enclosure;
a door for trapping the fish within the enclosure;
characterized in that the trap has a reflective surface positioned opposite the opening, such that a fish at said opening can see its own reflection, thereby attracting the fish into the enclosure.

2. A fish trap as claimed in claim 1, wherein the reflective surface is positioned on a portion of one or more internal walls of the enclosure.

3. A fish trap as claimed in claim 1, wherein the reflective surface is suspended within the enclosure.

4. A fish trap as claimed in claim 1, further comprising means for selectively changing the size of the opening.

5. A fish trap as claimed in claim 4, wherein the size of the opening is changed by slidably mounting one of a plurality of panels containing different sized apertures over the opening.

6. A fish trap as claimed in claim 1, wherein the door is slidably mounted over the opening.

7. A fish trap as claimed in claim 6, wherein the door is slidably mounted within first and second guides positioned either side of the opening.

8. A fish trap as claimed in claim 1, wherein the door has remote activating means for enabling the door to move between the open position and the closed position.

9. A fish trap as claimed in claim 8, wherein the door moves between the open position and closed position under gravitational force.

10. A fish trap as claimed in claim 1, wherein the enclosure has a second opening for allowing bait to be inserted into the enclosure.

11. A fish trap as claimed in claim 10, further comprising a hollow channel extending outwardly from the second opening for aiding the insertion of bait.

12. A fish trap as claimed in claim 10, wherein the second opening is provided on an upper surface of the enclosure.

13. A fish trap as claimed in claim 1, wherein the reflective surface is a mirror.

14. A fish trap as claimed in claim 1, wherein the enclosure is made from transparent material.

15. A fish trap, as claimed in claim 1, having a decoy to attract the fish into the enclosure.

16. A method for capturing a fish, the method comprising:
providing an enclosure having an opening for allowing the fish to enter the enclosure;
providing a door for trapping the fish within the enclosure;
characterized in that a reflective surface is positioned opposite the opening, such that a fish at said opening can see its own reflection, thereby attracting the fish into the enclosure.

17. (canceled)
